(19) United States
(12) Patent Application Publication
(10) Pub. No.: US 2026/0172239 A1
(43) Pub. Date: Jun. 18, 2026

(54) Quantum-powered artificial intelligence platform for proactive, global cyber defense

(71) Applicant: RAVICHANDRA DHAVAL, McKinney, TX (US)

(72) Inventor: RAVICHANDRA DHAVAL, McKinney, TX (US)

(21) Appl. No.: 19/440,089

(22) Filed: Jan. 5, 2026

(51) Int. Cl. H04L 9/08; G06N 3/092; G06N 10/60; H04L 9/40

(52) U.S. Cl. CPC H04L 9/085; G06N 3/092; G06N 10/60; H04L 63/1433

(57) ABSTRACT

A quantum-powered artificial intelligence platform for proactive cyber defense is disclosed. The platform simulates and defends against all possible attack paths in real time using quantum computing and AI, enables global, privacy-preserving threat intelligence sharing, and autonomously orchestrates defense measures. The invention shifts cyber defense from a reactive to a proactive model, providing near-impenetrable protection against sophisticated and coordinated cyber threats.

### BACKGROUND OF THE INVENTION

Conventional cyber defense systems are predominantly reactive, relying on post-attack detection and manual response. These systems are limited by classical computing's inability to efficiently simulate complex attack paths, optimize defense strategies, or facilitate secure, large-scale threat intelligence sharing. As cyber threats grow in sophistication and scale, especially with coordinated global campaigns, there is a critical need for a proactive, scalable, and collaborative defense platform. No current solution provides real-time, quantum-powered simulation of all possible attack vectors, nor does any system enable global, privacy-preserving sharing of threat intelligence and automated orchestration of defense measures.

### SUMMARY OF THE INVENTION

The invention provides a quantum-powered artificial intelligence (AI) platform for proactive cyber defense. The platform comprises a Quantum Simulation Engine (QSE), which utilizes quantum computing to model and simulate exponentially large attack graphs and potential adversary paths in real time. An AI-Driven Defense Orchestration Module (AIDOM) employs quantum-enhanced reinforcement learning and optimization algorithms to autonomously recommend and deploy optimal defense strategies. A Federated Threat Intelligence Network (FTIN) enables organizations to share anonymized or privacy-preserving threat intelligence, leveraging advanced cryptographic techniques to ensure data confidentiality and regulatory compliance. An Integration Layer provides application programming interfaces (APIs) and middleware for interoperability with existing cyber security tools (e.g., Security Information and Event Management (SIEM), Security Orchestration, Automation, and Response (SOAR), extended Detection and Response (XDR)). Finally, a Continuous Adaptation Engine updates simulations and defense recommendations dynamically as new threat intelligence, vulnerabilities, and system changes are detected. The platform shifts cyber defense from reactive to proactive, enabling real-time, collaborative, and automated protection against sophisticated and global cyber threats.

### BRIEF DESCRIPTIONS OF THE DRAWINGS

The accompanying drawings, where like numerals indicate like components, illustrate embodiments of the invention.

FIG. 1 is a system architecture diagram of the quantum-powered artificial intelligence platform.

FIG. 2 is a process flow diagram for quantum simulation and defense orchestration.

FIG. 3 is a process flow diagram for federated threat intelligence sharing and is a data flow diagram for privacy-preserving threat intelligence exchange

FIG. 4 is a data transformation diagram illustrating the Semantic Normalization Engine converting legacy STIX objects into a quantum-ready Hamiltonian matrix.

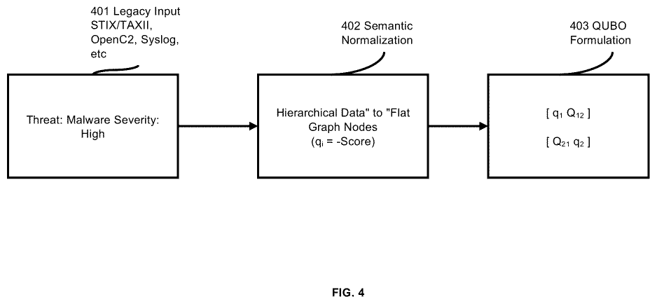

### DETAILED DESCRIPTION OF THE INVENTION

The following descriptions relate principally to preferred embodiments while a few alternative embodiments may also be referenced on occasion, although it should be understood that many other alternative embodiments would also fall within the scope of the invention. The embodiments disclosed are not to be construed as describing limits to the invention, whereas the broader scope of the invention should instead be considered with reference to the claims, which may be now appended or may later be added or amended in this or related applications. Unless indicated otherwise, it is to be understood that terms used in these descriptions generally have the same meanings as those that would be understood by people of ordinary skill in the art. It should also be understood that the terms used are generally intended to have the ordinary meanings that would be understood within the context of the related art, and they generally should not be restricted to formal or ideal definitions, unless and only to the extent that a particular context clearly requires otherwise. Synonymous or equivalent terms may be used in different instances in the specification and should not be construed to limit the invention.

For purposes of these descriptions, a few wording simplifications should also be understood as universal, except to the extent otherwise clarified in a particular context either in the specification or in the claims. The use of the term “or” should be understood as referring to alternatives, although it is generally used to mean “and/or” unless explicitly indicated to refer to alternatives only, or unless the alternatives are inherently mutually exclusive. Furthermore, unless explicitly dictated by the language, the term “and” may be interpreted as “or” in some instances. When referencing values, the term “about” may be used to indicate an approximate value, generally one that could be read as being that value plus or minus half of the value. “A” or “an” and the like may mean one or more, unless clearly indicated otherwise. Such “one or more” meanings are most especially intended when references are made in conjunction with open-ended words such as “having,” “comprising” or “including.” Likewise, “another” object may mean at least a second object or more. Thus, in the context of this specification, the term “comprising” is used in an inclusive sense and thus should be understood as meaning “including, but not limited to.” As used herein, the use of “may”, “may be”, “can”, or “can be”, indicates that a modified term is appropriate, capable, or suitable for an indicated capacity, function, or usage, while considering that in some circumstances the modified term may sometimes not be appropriate, capable, or suitable. Directional terms such as left, right, front, rear, top, and bottom are non-limiting and do not restrict the invention to particular orientations. Example quantities and sizing dimensions are described herein but do not limit the invention, as other sizes and quantities can be implemented. “Plurality” means two or more in this specification and any claims. Like reference numerals refer to like elements throughout.

Generally, software and computer-implemented systems comprise programming modules that include routines, programs, components, data structures, and other types of structures that perform particular tasks or implement particular abstract data types. A computing device, as used herein, refers to a device comprising at least a memory and a processor. A “computing device” may comprise a desktop, a laptop, a mobile phone, a smartphone, a tablet, a smart watch, and any other device able to support the features described herein.

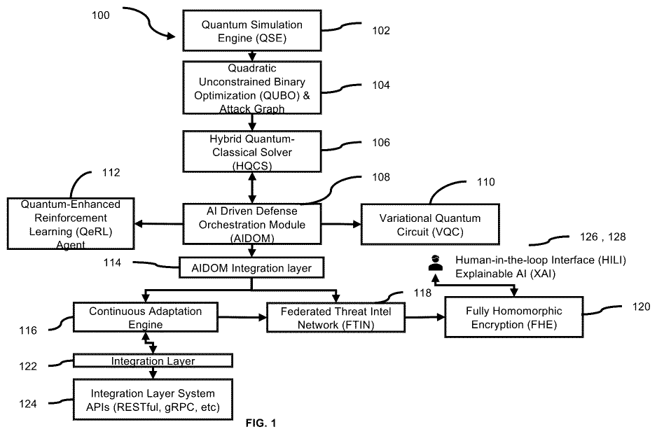

As illustrated in FIG. 1, the invention is a system for a cyber defense platform 100 utilizing quantum computing. The platform is loaded onto at least one processor. A quantum simulation engine (QSE) 102 is configured to receive at least one of real-time threat intelligence and system data. A plurality of quantum computing algorithms is configured for the QSE 102 model and simulates attack graphs 104 representing potential adversary paths in a digital infrastructure. The plurality of quantum computing algorithms comprises quantum Monte Carlo methods, quantum reinforcement learning, and quadratic unconstrained binary optimization (QUBO)-based optimization.

The QSE 102 receives system topology, asset data, vulnerability data, and threat intelligence feeds. Its inventive step is the compilation of the entire network attack graph into a Quadratic Unconstrained Binary Optimization (QUBO) problem. Attack graph construction involves nodes representing assets, users, vulnerabilities, and controls, and edges representing possible attack vectors, with quantum algorithms (e.g., Grover's search, quantum walks) used to efficiently explore large graphs.

This complex graph, which is combinatorially explosive, is formulated as an objective function to be minimized:

$$\$\$ ∖ min\_ \{ x \} ∖ sum\_ \{ i \} q\_i x\_i + ∖ sum\_ \{ i < j \} Q\_ \{ ij \} x\_i x\_j\$\$$$

Where:
x_i is a binary variable (1 or 0) representing the decision to use exploit i.
q_i is a linear coefficient (a ‘bias’) representing the cost (e.g., time, resources) or impact (e.g., risk score) of exploit i.
Q_{ij} is a quadratic coefficient representing the conditional relationship or prerequisite between exploit i and j (e.g., exploit j is only possible if exploit i is used first).

This specific QUBO formulation is a non-obvious implementation that translates the abstract problem into a solvable mathematical object. It allows the QSE 102 to utilize hybrid quantum-classical solvers (HQCS) 106 (e.g., quantum annealers on D-Wave hardware or the Quantum Approximate Optimization Algorithm (QAOA) on gate-based hardware like IBM Q, IonQ, or Rigetti) to find the global minimum. This minimum corresponds to the most damaging or most probable adversary attack path(s), identified in near-real-time.

AI-Driven Defense Orchestration Module (AIDOM) 108 ingests attack graphs 104 and calculated optimal attack path solutions from the QSE. AIDOM 108 employs a quantum-enhanced reinforcement learning (QeRL) 112 agent to determine the optimal defensive strategy. It interfaces with the organization's cyber defense infrastructure to deploy countermeasures (e.g., network segmentation, access control, patching). Deployment is policy-based, utilizing a Human-in-the-Loop Interface (HILI) 128 to provide an override for critical actions. The module employs adversarial machine learning (ML) defense techniques to detect and mitigate anomalous or malicious inputs in threat intelligence feeds. It also provides Explainable AI (XAI) 126, generating human-readable rationales, risk scores, and impact analysis for each defense measure. The AIDOM then autonomously deploys these countermeasures via the AIDOM Integration Layer 114.

The state space (all possible network configurations) and action space (all possible combinations of patching, segmentation, and access control changes) are combinatorially large. To solve this, the AIDOM 108 implements an Actor-Critic reinforcement learning model. The ‘Actor’ proposes a defense policy, and the ‘Critic’ evaluates the value of that policy. In a novel and non-obvious step, the ‘Critic’ is implemented as a Variational Quantum Circuit (VQC) 110. By leveraging the high-dimensional Hilbert space, the VQC 110 serves as a more powerful and efficient function approximator for this complex value function than any classical deep neural network. This allows the AIDOM 108 to identify non-obvious, minimal defensive actions (e.g., “segment 3 networks and patch 5 critical servers”) that provide the maximum reduction in risk, a feat computationally infeasible for the classical RL taught in the prior art.

In a preferred embodiment, the ‘Critic’ component of the Actor-Critic reinforcement learning model is implemented as a Variational Quantum Circuit (VQC) utilizing a Hardware-Efficient Ansatz (HEA). Unlike generic quantum circuits, the HEA is specifically constructed to minimize circuit depth and reduce decoherence noise on Near-Intermediate Scale Quantum (NISQ) processors.

The VQC comprises three distinct stages:
1. State Preparation (Embedding Layer): The classical state vector $s$ (representing the current network security posture) is mapped to the quantum Hilbert space using angle encoding, where each feature of the state vector determines the rotation angle of a qubit gate (e.g., $R_y (\theta) $).
2. Variational Layers (The ‘Brain’): The circuit executes a sequence of parameterized quantum gates consisting of single-qubit rotations ($R_x, R_z$) and two-qubit entangling gates (e.g., CNOT or CZ). The arrangement of these gates follows a specific topology (e.g., a ring or grid) matching the physical connectivity of the quantum processor (e.g., superconducting transmon or trapped ion coupling map). This physical mapping reduces the need for SWAP gates, significantly lowering error rates.
3. Measurement: The expectation values of the Pauli-Z operator are measured on specific qubits to derive the ‘Value Function’ $V(s) $, which estimates the quality of the proposed defense strategy.
   The training of this VQC utilizes the Parameter Shift Rule, a method allowing the classical optimizer to calculate the exact gradient of the quantum circuit with respect to its parameters, ensuring the quantum ‘Critic’ can learn from the classical ‘Actor's’ feedback without requiring numerical differentiation

A Federated Threat Intelligence Network (FTIN) 118 enables organizations to share fully encrypted threat data using privacy-preserving techniques. These techniques include homomorphic encryption for computation on encrypted data, differential privacy for anonymization, and secure multi-party computation for collaborative analysis without revealing raw data. Fully Homomorphic Encryption (FHE) 120 (e.g., the CKKS scheme for real-number arithmetic) allows the platform to perform global analysis and construct global attack models directly on ciphertext without decryption, overcoming the “leaky” privacy vulnerabilities of prior art federated learning models. Unlike standard federated learning which shares “model updates” that are vulnerable to inference attacks, the FTIN 118 uses an FHE scheme (e.g., CKKS (Cheon-Kim-Kim-Song) for real-number arithmetic) to allow participants to share fully encrypted ciphertext. It supports secure enclave technology (e.g., Intel SGX, ARM TrustZone) for hardware-based isolation and enforces policy-based sharing with automated compliance checks for regulations like GDPR, CCPA, and HIPAA.

To facilitate privacy-preserving collaboration without a central point of failure, the Federated Threat Intelligence Network (FTIN) employs a Distributed Key Generation (DKG) protocol combined with Threshold Cryptography. In this configuration, the private decryption key $sk$ is never generated or stored in a single location.

Instead, the private key is mathematically fragmented into $n$ shares ($sk_1, sk_2, . . . sk_n$) distributed among the participating organizations. A valid decryption or signature operation requires a quorum (threshold $t$) of participants to collaborate (where $t<n$). This ensures that even if the central platform is compromised, the raw threat intelligence data of the participants cannot be decrypted.

The aggregation of threat models is performed using Secure Multi-Party Computation (SMPC) protocols (e.g., SPDZ or Yao's Garbled Circuits), allowing the global QSE to update its attack graph weights based on the encrypted inputs of all participants without ever revealing the underlying data.

The FTIN's 118 global analysis module performs computations (e.g., statistical analysis, anomaly detection, and aggregation of a global QUBO model) directly on the encrypted ciphertext. At no point is plaintext data ever exposed, even to the platform operator. This is a fundamentally distinct and more secure architecture than prior art. The network also utilizes differential privacy for anonymization and secure enclave technology (e.g., Intel SGX) for hardware-based isolation during computation.

Continuous adaptation engine 116 monitors system changes, new vulnerabilities, and feedback from deployed defense actions. It dynamically triggers the QSE 102 to reformulate the QUBO model and the AIDOM 108 to retrain the QeRL agent 112, creating a continuous, adaptive feedback loop. It dynamically updates attack graph simulations and defense strategies. It employs statistical and ML-based anomaly detection algorithms to identify deviations from normal patterns and trigger immediate re-simulation and defense strategy updates upon detection of novel threats. It incorporates feedback loops to dynamically retrain AI models and update simulation parameters based on defense outcomes and threat landscape changes.

Integration layer 122 provides secure APIs 124 (e.g., RESTful, gRPC) and middleware for interoperability with an organization's existing cyber security stack, including SIEM, SOAR, and XDR platforms. It performs automated data mapping and normalization, translating disparate log formats (e.g., CEF, Syslog, JSON, XML) into a unified schema for the QSE 102 and AIDOM 108. Authentication and authorization utilize industry standards (e.g., OAuth2, SAML) and role-based access controls, with audit trails for all data exchanges.

The Integration Layer comprises a Semantic Normalization Engine configured to bridge the gap between deterministic legacy security protocols and the probabilistic quantum simulation models. This engine utilizes a specific ontology mapping process:
1. Ingestion: The engine accepts data via RESTful APIs formatted in industry-standard schemas, including STIX/TAXII (for threat intelligence), OpenC2 (for command and control), and Syslog (for event data).
2. Ontological Mapping: A graph-based transformer converts these hierarchical data structures into flat graph nodes. For example, a STIX ‘Malware’ object is mapped to a specific ‘Exploit Node’ in the QSE's attack graph.
3. Variable Weighting: Crucially, the engine translates the qualitative attributes of the legacy data (e.g., a ‘High’ severity rating in a firewall log) into quantitative bias coefficients ($q_i$) and coupling strengths ($Q_{ij} $) required for the QUBO formulation.
   This automated translation allows the system to interface with legacy firewalls, SIEMs, and XDR platforms transparently, effectively converting a classical network topology into a quantum-ready Hamiltonian without manual intervention.

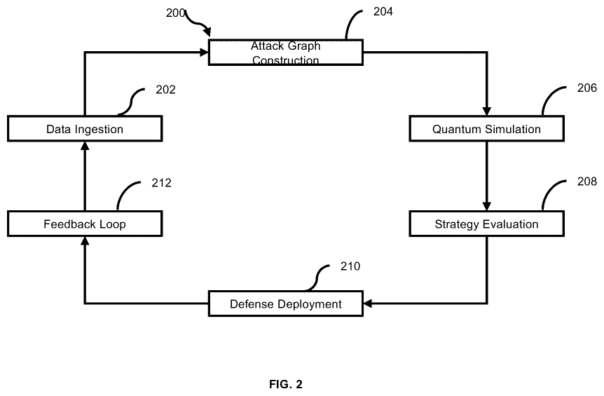

As illustrated in FIG. 2, the proactive defense loop 200 proceeds as follows:

Data Ingestion 202: The platform ingests system topology, asset inventory, vulnerability scans, and threat intelligence from the FTIN.

Attack Graph Construction 204: The QSE constructs the high-dimensional attack graph and, as an inventive step, formulates it as a QUBO problem.

Quantum Simulation 206: The QSE uses hybrid quantum-classical solvers to find the optimal solution (global minimum) of the QUBO, identifying the most critical attack paths.

Strategy Evaluation 208: The AIDOM's QeRL-VQC ‘Critic’ evaluates the attack paths from the QSE against the current network state to determine the optimal, minimal-cost defense policy.

Defense Deployment 210: The AIDOM's ‘Actor’ autonomously deploys the selected countermeasures (e.g., network segmentation, patching, access control changes) via the Integration Layer.

Feedback Loop 212: The Continuous Adaptation Engine monitors the outcome of the deployed defense, system changes, and new threats, feeding this data back to the QSE and AIDOM to dynamically retrain and update the models.

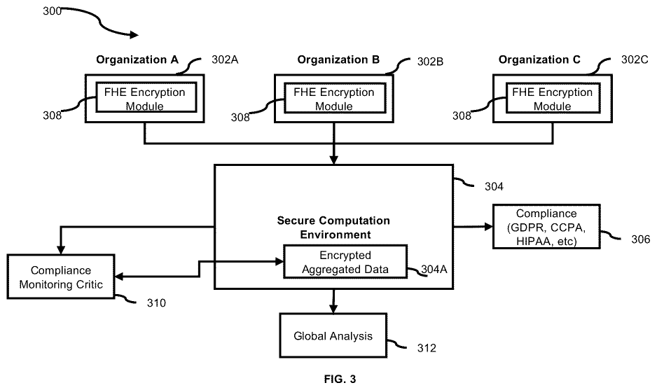

As illustrated in FIG. 3, the federated sharing process provides the critical data for the simulation engine while guaranteeing privacy.

Threat Data Preparation: Each organization 302A, 302B, 302C, prepares its local threat data. As shown in FIG. 3, this data is encrypted at the source using an FHE Encryption Module 308 (e.g., implementing the CKKS scheme).

Privacy-Preserving Aggregation: The FTIN aggregates the encrypted ciphertext from all participants into a Secure Computation Environment 304.

Global Analysis 312: In this environment, the platform's quantum-powered AI performs computations directly on the encrypted data. This may include statistical analysis of emerging attack patterns or even the aggregation of a global QUBO model. Because of FHE, this is achieved without ever decrypting the data, providing provable privacy and overcoming the vulnerabilities of prior art.

Intelligence Dissemination: Only the aggregated, anonymized insights 304A or defense recommendations are distributed back to participants. All access is governed by strict policies and audit trails.

Compliance Monitoring 310: The system ensures all data sharing and computation complies with regulations 306 like GDPR, CCPA, and HIPAA.

Data is encrypted at source using homomorphic encryption or differential privacy. Secure multi-party computation enables collaborative analysis without exposing raw data in a Secure Computation Environment. Only aggregated, anonymized insights are shared across the network. Data access and sharing are governed by strict policies and audit trails.

This synergistic architecture creates a non-obvious, computationally unified platform that solves the core limitations of prior art by specifically (1) formulating attack paths as a tractable QUBO, (2) solving defense strategy with a QeRL-VQC critic, and (3) enabling secure global data sharing with FHE.

Various other features for, modifications to and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included herein. Although specific terms are employed herein, they are used in a generic and descriptive sense only and not for purposes of limitation.

While I/we reserve the right to claim more particularly at a later date, we claim:

1. A computer-implemented method for proactive cyber defense utilizing a hybrid quantum-classical architecture, the method comprising:
constructing, by a classical processor, a directed attack graph representing a network topology, wherein nodes represent computing assets and edges represent vulnerability exploit paths;
transforming, by a Semantic Normalization Engine, the directed attack graph into a Quadratic Unconstrained Binary Optimization (QUBO) problem formulation, wherein qualitative vulnerability attributes are mapped to quantitative bias coefficients;
transmitting the QUBO problem formulation to a quantum processing unit (QPU) or quantum simulator;
receiving, from the QPU, a solution vector representing a minimum energy state corresponding to a most-probable adversary attack path;
evaluating the solution vector using a Variational Quantum Circuit (VQC) configured as a critic within a reinforcement learning agent; and
automatically executing, by an orchestration module, a defensive countermeasure identified by the reinforcement learning agent to preemptively block the adversary attack path.

2. The method of claim 1, wherein the Variational Quantum Circuit utilizes a Hardware-Efficient Ansatz (HEA) comprising a parameterized sequence of single-qubit rotation gates and two-qubit entangling gates arranged to match the physical coupling topology of the quantum processing unit.

3. The method of claim 1, further comprising aggregating threat intelligence from a plurality of external organizations using a Distributed Key Generation (DKG) protocol, wherein a private decryption key is fragmented into shares distributed among the organizations such that no single entity possesses the complete private key.

4. The method of claim 1, wherein the step of transforming the attack graph into a QUBO problem further comprises calculating a coupling strength, denoted as $Q_{ij} $, between two nodes based on a conditional probability of lateral movement between a first asset and a second asset within the network topology.

5. A proactive cyber defense system, comprising:
a classical memory storing a network topology;
a Semantic Normalization Engine configured to translate standard cyber threat intelligence feeds into a Hamiltonian matrix representation;
a Quantum Simulation Engine configured to minimize the Hamiltonian matrix to identify critical attack vectors;
a Reinforcement Learning Module comprising a classical actor neural network and a quantum critic circuit, wherein the quantum critic circuit estimates a value function of a proposed defense strategy;
and
an Integration Layer configured to deploy the defense strategy to network security appliances via OpenC2 or RESTful API commands.
